(19) United States
(12) Patent Application Publication
(10) Pub. No.: US 2019/0354743 A1
(43) Pub. Date: Nov. 21, 2019

(54) Apparatus and Method for Biometric Sampling

(71) Applicant: QUALCOMM Incorporated, San Diego, CA (US)

(72) Inventors: Ashish HINGER, Sunnyvale, CA (US); David William Burns, San Jose, CA (US); Bo-Ren WANG, San Diego, CA (US); Firas SAMMOURA, Dublin, CA (US); Sameer WADHWA, San Diego, CA (US); Lennart MATHE, San Diego, CA (US); Farhad TAGHIBAKHSH, Cupertino, CA (US)

(21) Appl. No.: 15/980,446

(22) Filed: May 15, 2018

(51) Int. Cl. G06K 9/00

(52) U.S. Cl. CPC G06K 9/00114; G06K 9/0002

(57) ABSTRACT

An apparatus and method for efficiently increasing the signal-to-noise ratio of a biometric sampling system by implementing differential-sampling in successive differential-sampling operations and processing the output of the successive differential-sampling operations to create a biometric image. In some cases, the biometric image may be further noise-reduced by subtracting foreground-off and background-off data.

### FIELD

The present disclosure relates to the field of biometric sampling. In particular, the present disclosure relates to apparatuses and methods for peak-to-peak fingerprint image capture.

### BACKGROUND

Fingerprint sensing and matching is a commonly used technique for personal identification or verification. For example, one approach to fingerprint identification involves scanning a sample fingerprint or an image with a biometric reader/sensor and storing the image and/or unique characteristics of the fingerprint image. The characteristics of a sample fingerprint may then be compared to information for reference fingerprints already in a database to determine proper identification of a person, such as for verification purposes.

Biometric sensors, particularly fingerprint biometric sensors, may suffer from low signal-to-noise ratios (SNRs) which impact image quality and can limit the detection of various finger features. The detection of more minute finger features enables a more accurate match to authorized finger features. Therefore, low SNR can negatively affect the false rejection rate and false acceptance rate.

As ultrasonic sensors have become increasingly popular in mobile devices, it is desirable to have apparatuses and methods which can increase the SNR beyond that capable with conventional apparatuses and methods.

### SUMMARY

Embodiments of apparatuses and methods for biometric sampling are disclosed. According to an aspect of the present disclosure, a method for biometric sampling by an ultrasonic fingerprint sensor may comprise transmitting, by an ultrasonic transmitter, an ultrasonic wave such that the wave reflects from the object. Such an object may be a finger, a stylus, the surface of a platen, or the surface/air interface of a platen. The method may also comprise performing successive differential-sampling operations, using a differential pixel of an array of differential pixels, to determine a set of sample differences. The sample differences may comprise the difference between one sample, sample(n) at a first range-gate delay (n) (RGD), and a second sample at a second RGD(n+1). Each sample difference is added to the set of sample differences for processing to create at least a portion of biometric image data. The differential-sampling operation may be repeated up to a programmed or predetermined limit of iterations. Alternatively, the differential-sampling operation may be repeated until a desired signal-to-noise (SNR) ratio is reached. For each successive differential-sampling operation, RGD(n) and RGD(n+1) may change to accommodate the acquisition time of new samples.

The set sample differences may be processed to create at least a portion of a biometric image. In some embodiments, a portion of ultrasonic pixels of the ultrasonic pixel array may perform a different number of differential-sampling operations, thereby creating a set of sample differences that is a different size from a set of sample differences from a separate portion of ultrasonic pixels.

According to an aspect of the present disclosure, a method for biometric sampling by an ultrasonic fingerprint sensor may comprise transmitting, by an ultrasonic transmitter, an ultrasonic wave such that the wave reflects from the object. Such an object may be a finger, a stylus, the surface of a platen, or the surface/air interface of a platen. The method may comprise capturing, with a differential pixel a sample(n) of the reflected ultrasonic wave at an RGD(n). The method may also comprise performing successive differential-sampling operations, using a differential pixel of an array of differential pixels, to determine a set of sample differences. The sample differences may comprise the difference between one sample, sample(n) at a first range-gate delay (n) (RGD), and a second sample at a second RGD(n+1). Each sample difference is added to the set of sample differences for processing to create at least a portion of biometric image data. The differential-sampling operation may be repeated up to a programmed or predetermined limit of iterations. Alternatively, the differential-sampling operation may be repeated until a desired signal-to-noise (SNR) ratio is reached. For each successive differential-sampling operation, RGD(n+1) may change to accommodate the acquisition time of new samples. For each determination of sample differences, a difference may be determined between sample(n+1) and reference sample(n).

According to an aspect of the present disclosure, an apparatus for biometric sampling by an ultrasonic fingerprint sensor may comprise an ultrasonic transmitter configured to transmit, an ultrasonic wave such that the wave reflects from the object. Such an object may be a finger, a stylus, the surface of a platen, or the surface/air interface of a platen. The apparatus may also comprise a controller configured to perform successive differential-sampling operations, using a differential pixel of an array of differential pixels, to determine a set of sample differences. The sample differences may comprise the difference between one sample, sample(n) at a first range-gate delay (n) (RGD), and a second sample at a second RGD(n+1). Each sample difference is added to the set of sample differences for processing to create at least a portion of biometric image data. The differential-sampling operation may be repeated up to a programmed or predetermined limit of iterations. Alternatively, the differential-sampling operation may be repeated until a desired signal-to-noise (SNR) ratio is reached. For each successive differential-sampling operation, RGD(n) and RGD(n+1) may change to accommodate the acquisition time of new samples.

The controller may be configured to create at least a portion of a biometric image. In some embodiments, the controller may be configured such that a portion of ultrasonic pixels of the ultrasonic pixel array may perform a different number of differential-sampling operations, thereby creating a set of sample differences that is a different size from a set of sample differences from a separate portion of ultrasonic pixels.

According to an aspect of the present disclosure, an apparatus for biometric sampling by an ultrasonic fingerprint sensor may comprise an ultrasonic transmitter configured to transmit, an ultrasonic wave such that the wave reflects from the object. Such an object may be a finger, a stylus, the surface of a platen, or the surface/air interface of a platen. The apparatus may also comprise a controller configured to perform successive differential-sampling operations, using a differential pixel of an array of differential pixels, to determine a set of sample differences. The sample differences may comprise the difference between one sample, sample(n) at a first range-gate delay (n) (RGD), and a second sample at a second RGD(n+1). Sample(n) may be acquired before the successive differential-sampling operation, such that it acts as a reference sample for successive sampling operations. Each sample difference is added to the set of sample differences for processing to create at least a portion of biometric image data. The differential-sampling operation may be repeated up to a programmed or predetermined limit of iterations. Alternatively, the differential-sampling operation may be repeated until a desired signal-to-noise (SNR) ratio is reached. For each successive differential-sampling operation, RGD(n+1) may change to accommodate the acquisition time of new samples.

### BRIEF DESCRIPTION OF THE DRAWINGS

The aforementioned features and advantages of the disclosure, as well as additional features and advantages thereof, will be more clearly understandable after reading detailed descriptions of embodiments of the disclosure in conjunction with the non-limiting and non-exhaustive aspects of following drawings. Like numbers are used throughout the figures.

FIG. 1A illustrates an exemplary flow diagram of constant-spacing peak-to-peak fingerprint sampling.

FIG. 1B illustrates another exemplary flow diagram of fixed-reference peak-to-peak fingerprint sensing.

FIG. 2 illustrates an exemplary waveform view of an ultrasonic sensor response with constant-spacing peak-to-peak fingerprint sampling.

FIG. 3 illustrates an exemplary waveform view of an ultrasonic sensor response with fixed-reference peak-to-peak fingerprint sampling.

FIG. 4 illustrates an exemplary generalized block diagram of a peak-to-peak fingerprint sampling apparatus.

FIG. 5 illustrates an exemplary differential ultrasonic pixel array.

FIG. 6 illustrates an exemplary ultrasonic signal showing associated reset and trigger inputs.

FIG. 7 illustrates an exemplary circuit for differential peak-to-peak sampling

FIG. 8 illustrates exemplary slanted-target fingerprint images taken at multiple RGDs.

FIG. 9 illustrates exemplary superimposed waveforms of multiple signals taken from a differential peak-to-peak fingerprint sampling system.

FIG. 10 illustrates an exemplary block diagram of a mobile device which may incorporate a differential peak-to-peak fingerprint sampling system.

FIGS. 11A-C illustrate an exemplary side-view of a differential peak-to-peak fingerprint sampling system.

FIG. 12 illustrates an exemplary simplified block diagram of a differential peak-to-peak fingerprint sampling system.

### DETAILED DESCRIPTION

Embodiments of apparatuses and methods for biometric sampling are disclosed. The following descriptions are presented to enable any person skilled in the art to make and use the disclosure. Descriptions of specific embodiments and applications are provided only as examples. Various modifications and combinations of the examples described herein will be readily apparent to those skilled in the art, and the general principles defined herein may be applied to other examples and applications without departing from the scope of the disclosure. Thus, the present disclosure is not intended to be limited to the examples described and shown, but is to be accorded the scope consistent with the principles and features disclosed herein. The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

According to an aspect of the present disclosure, a method for biometric sampling by an ultrasonic fingerprint sensor may comprise transmitting, by an ultrasonic transmitter, an ultrasonic wave such that the wave reflects from the object. Such an object may be a finger, a stylus, the surface of a platen, or the surface/air interface of a platen. The method may also comprise performing successive differential-sampling operations, using a differential pixel of an array of differential pixels, to determine a set of sample differences. The sample differences may comprise the difference between one sample, sample(n) at a first range-gate delay (n) (RGD), and a second sample at a second RGD(n+1). Each sample difference is added to the set of sample differences for processing to create at least a portion of biometric image data. The differential-sampling operation may be repeated up to a programmed or predetermined limit of iterations. Alternatively, the differential-sampling operation may be repeated until a desired signal-to-noise (SNR) ratio is reached. For each successive differential-sampling operation, RGD(n) and RGD(n+1) may change to accommodate the acquisition time of new samples.

The set sample differences may be processed to create at least a portion of a biometric image. In some embodiments, a portion of ultrasonic pixels of the ultrasonic pixel array may perform a different number of differential-sampling operations, thereby creating a set of sample differences that is a different size from a set of sample differences from a separate portion of ultrasonic pixels.

The set of sample differences may comprise a set of separate values to be processed, or the set may comprise an average, or other mathematical combination of sample differences.

In some embodiments, the method may also comprise acquiring foreground-off (FGoff) and background-off (BGoff) image data, and processing a portion of the biometric image data together with the FGoff and BGoff image data. The FGoff image data may comprise image data taken from a foreground, or target zone, or area where an object is placed against the platen of a fingerprint reader, when the ultrasound transmitter is off. The BGoff image data may comprise image data taken from a background, or non-target zone, or area where an object is not placed against the platen of a fingerprint reader, when the ultrasound transmitter is off. Subtracting the FGoff image data from the foreground of a biometric image and subtracting the BGoff image data from the background of a biometric image may produce a biometric image with lower noise, also known as a noise-reduced image.

In some embodiments, the method may also comprise sending a reset signal to at least one differential pixel of the ultrasonic pixel array after the start of a transmit signal is sent to the ultrasonic signal. The reset signal may cause the voltage on the pixel readout to settle, thereby clearing out the effects of any previous signals.

In some embodiments, RGD(n+1) is longer than RGD(n) such that sample(n+1) is captured at a later time than sample(n).

In some embodiments, sample(n) and sample(n+1) are triggered by input pulses of a control waveform to the differential pixel, such that each full input pulse, with a rising and a falling edge, triggers a sample. For example, an input pulse, with a rising and a falling edge, triggers sample(n). Thereafter, a second input pulse, with a rising and a falling edge, triggers sample(n+1).

In other embodiments, a trigger may occur for one sample, for example sample(n), on the rising-edge of an input signal, and a second trigger may occur for a second sample, for example sample(n+1).

In some embodiments, a temporal delay between RGD(n+1) and RGD(n) is an odd-integer-multiple of half the period of an ultrasonic transmitter wave drive frequency. For example, at 20 MHz, half the period would be 50 ns—therefore RGD(n+1) may be, for example, 50, 150 ns, or 250 ns temporally delayed from RGD(n). Sampling at odd-integer-multiple RGDs for sample(n+1) provides the ability to sample at a trough (if sample(n) is at a peak) or to sample at a peak (if sample(n) is at a trough). This temporal delay between RGD(n+1) and RGD(n) may remain constant throughout the successive differential-sampling operations.

In some embodiments, RGD(n) may be selected to sample at or near a peak, or at or near a trough, of a reflected ultrasonic wave.

In some embodiments, the method may also comprise operating point-spread function (PSF) upon a combination of multiple noise-reduced biometric images.

According to an aspect of the present disclosure, a method for biometric sampling by an ultrasonic fingerprint sensor may comprise transmitting, by an ultrasonic transmitter, an ultrasonic wave such that the wave reflects from the object. Such an object may be a finger, a stylus, the surface of a platen, or the surface/air interface of a platen. The method may comprise capturing, with a differential pixel a sample(n) of the reflected ultrasonic wave at an RGD(n). The method may also comprise performing successive differential-sampling operations, using a differential pixel of an array of differential pixels, to determine a set of sample differences. The sample differences may comprise the difference between one sample, sample(n) at a first range-gate delay (n) (RGD), and a second sample at a second RGD(n+1). Each sample difference is added to the set of sample differences for processing to create at least a portion of biometric image data. The differential-sampling operation may be repeated up to a programmed or predetermined limit of iterations. Alternatively, the differential-sampling operation may be repeated until a desired signal-to-noise (SNR) ratio is reached. For each successive differential-sampling operation, RGD(n+1) may change to accommodate the acquisition time of new samples. For each determination of sample differences, a difference may be determined between sample(n+1) and reference sample(n).

According to an aspect of the present disclosure, an apparatus for biometric sampling by an ultrasonic fingerprint sensor may comprise an ultrasonic transmitter configured to transmit, an ultrasonic wave such that the wave reflects from the object. Such an object may be a finger, a stylus, the surface of a platen, or the surface/air interface of a platen. The apparatus may also comprise a controller configured to perform successive differential-sampling operations, using a differential pixel of an array of differential pixels, to determine a set of sample differences. The sample differences may comprise the difference between one sample, sample(n) at a first range-gate delay (n) (RGD), and a second sample at a second RGD(n+1). Each sample difference is added to the set of sample differences for processing to create at least a portion of biometric image data. The differential-sampling operation may be repeated up to a programmed or predetermined limit of iterations. Alternatively, the differential-sampling operation may be repeated until a desired signal-to-noise (SNR) ratio is reached. For each successive differential-sampling operation, RGD(n) and RGD(n+1) may change to accommodate the acquisition time of new samples.

The controller may be configured to create at least a portion of a biometric image. In some embodiments, the controller may be configured such that a portion of ultrasonic pixels of the ultrasonic pixel array may perform a different number of differential-sampling operations, thereby creating a set of sample differences that is a different size from a set of sample differences from a separate portion of ultrasonic pixels.

In some embodiments, the controller may also be configured to acquire foreground-off (FGoff) and background-off (BGoff) image data, and process a portion of the biometric image data together with the FGoff and BGoff image data. The FGoff image data may comprise image data taken from a foreground, or target zone, or area where an object is placed against the platen of a fingerprint reader, when the ultrasound transmitter is off. The BGoff image data may comprise image data taken from a background, or non-target zone, or area where an object is not placed against the platen of a fingerprint reader, when the ultrasound transmitter is off. A controller configured to subtract the FGoff image data from the foreground of a biometric image and subtract the BGoff image data from the background of a biometric image may produce a biometric image with lower noise.

In some embodiments, the apparatus may also be configured to send a reset signal to at least one differential pixel of the ultrasonic pixel array after the start of a transmit signal is sent to the ultrasonic signal. The reset signal may cause the voltage on the pixel readout to settle, thereby clearing out the effects of any previous signals.

In some embodiments of the apparatus, RGD(n+1) is longer than RGD(n) such that sample(n+1) is captured at a later time than sample(n).

In some embodiments of the apparatus, sample(n) and sample(n+1) are triggered by input pulses of a control waveform to the differential pixel, such that each full input pulse, with a rising and a falling edge, triggers a sample. For example, an input pulse, with a rising and a falling edge, triggers sample(n). Thereafter, a second input pulse, with a rising and a falling edge, triggers sample(n+1).

In other embodiments of the apparatus, a trigger may occur for one sample, for example sample(n), on the rising-edge of an input signal, and a second trigger may occur for a second sample, for example sample(n+1).

In some embodiments of the apparatus, a temporal delay between RGD(n+1) and RGD(n) is an odd-integer-multiple of half the period of an ultrasonic transmitter wave drive frequency. For example, at 20 MHz, half the period would be 50 ns—therefore RGD(n+1) may be, for example, 50 ns, 150 ns, or 250 ns temporally delayed from RGD(n). Sampling at odd-integer-multiple RGDs for sample(n+1) provides the ability to sample at a trough (if sample(n) is at a peak) or to sample at a peak (if sample(n) is at a trough). This temporal delay between RGD(n+1) and RGD(n) may remain constant throughout the successive differential-sampling operations.

In some embodiments of the apparatus, RGD(n) may be selected to sample at or near a peak, or at or near a trough, of a reflected ultrasonic wave.

In some embodiments, the apparatus may also comprise a controller configured to operate a point-spread function (PSF) upon a combination of multiple noise-reduced biometric images.

According to an aspect of the present disclosure, an apparatus for biometric sampling by an ultrasonic fingerprint sensor may comprise an ultrasonic transmitter configured to transmit, an ultrasonic wave such that the wave reflects from the object. Such an object may be a finger, a stylus, the surface of a platen, or the surface/air interface of a platen. The apparatus may also comprise a controller configured to perform successive differential-sampling operations, using a differential pixel of an array of differential pixels, to determine a set of sample differences. The sample differences may comprise the difference between one sample, sample(n) at a first range-gate delay (n) (RGD), and a second sample at a second RGD(n+1). Sample(n) may be acquired before the successive differential-sampling operation, such that it acts as a reference sample for successive sampling operations. Each sample difference is added to the set of sample differences for processing to create at least a portion of biometric image data. The differential-sampling operation may be repeated up to a programmed or predetermined limit of iterations. Alternatively, the differential-sampling operation may be repeated until a desired signal-to-noise (SNR) ratio is reached. For each successive differential-sampling operation, RGD(n+1) may change to accommodate the acquisition time of new samples.

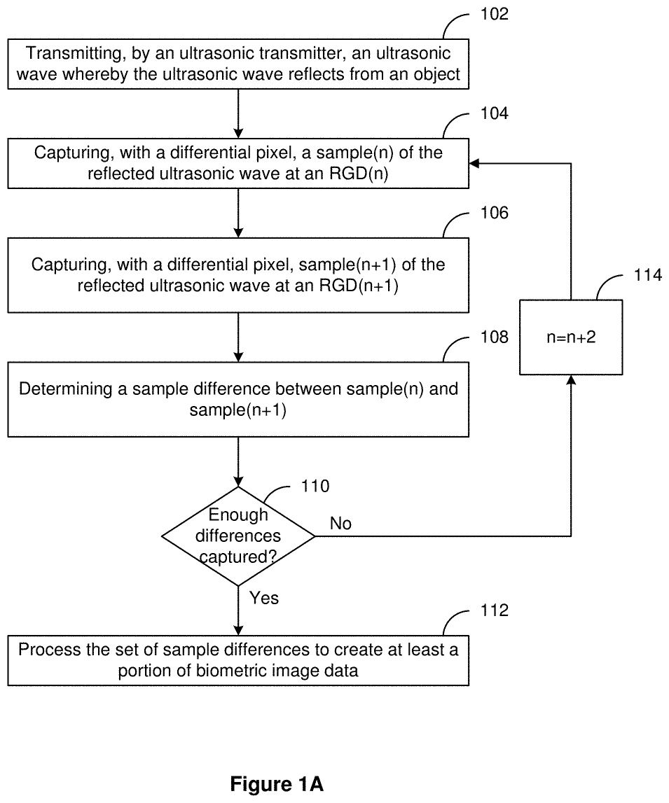

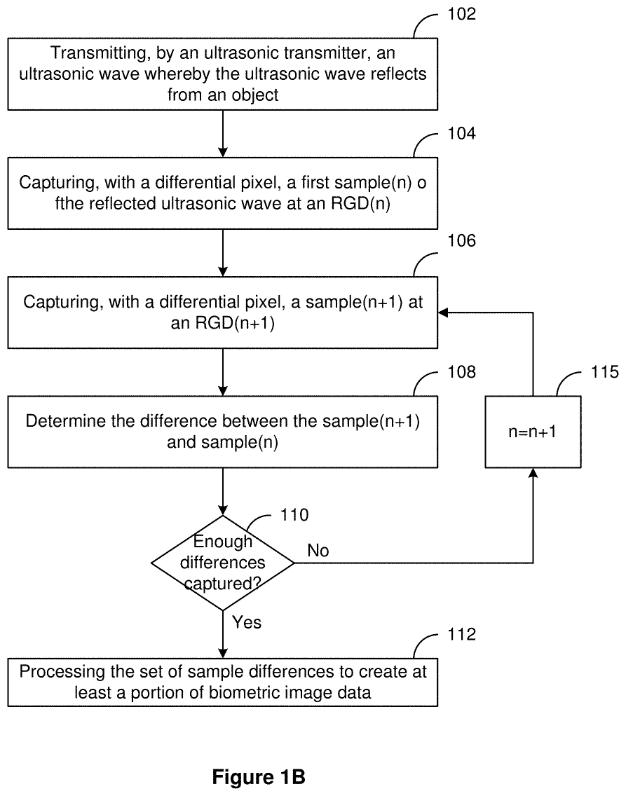

FIG. 1A illustrates an exemplary implementation for a method for biometric sampling. At block 102, an ultrasonic transmitter may transmit an ultrasonic wave. At block 104, a differential pixel captures a sample, sample(n), at an RGD(n). At block 106, a differential pixel captures a sample(n+1) at an RGD(n+1). At block 108, the difference is determined between the sample(n+1) and sample(n). At block 110, if there are enough differences captured (determined by, for example, whether a limit on successive differential-pixel sampling operations has been met), then a combination of the differences is processed at block 112. If there are not enough differences captured, then at block 114, the next RGD can be selected by incrementing n by 2, and the process continues at block 104.

FIG. 1A illustrates a constant-spacing mode of differential sampling, whereby each difference between samples is calculated as the difference between successive pairs of samples.

For example, a first sample may be captured at a peak, and a second sample at a trough. Thereafter the difference between the first and second sample is determined. For the next successive differential-sensing operation, a third sample may be captured at a peak, and a fourth sample may be captured at a trough, and thereafter the difference between the third and fourth sample is determined. The difference between the samples then represents the difference between the peak and the trough, or the peak-to-peak amplitude of the received signal. In this mode, the second RGD (RGD(n+1)) may be an odd-integer-multiple of ½ the period of the ultrasound wave temporally delayed from the first RGD.

FIG. 1B illustrates an exemplary implementation for a method for biometric sampling. At block 102, an ultrasonic transmitter may transmit an ultrasonic wave. At block 104, a differential pixel captures a sample, sample(n), at an RGD(n). At block 106, a differential pixel captures a sample(n+1) at an RGD(n+1). At block 108, the difference is determined between the sample(n+1) and sample(n). At block 110, if there are enough differences captured (determined by, for example, whether a limit on successive differential-pixel sampling operations has been met), then a combination of the differences is processed at block 112. If there are not enough differences captured, then at block 115, the next RGD can be selected by incrementing n by 1, and the process continues at block 106.

FIG. 1B illustrates a fixed-reference mode of differential sampling, whereby each difference between samples is calculated as the difference between successive samples and a fixed-reference sample. For example, a first sample may be captured at a peak, and a second sample at a trough. Thereafter, the difference between the first and second sample is calculated. Then a third sample is captured at a trough, thereafter the difference between the first and third sample is calculated, and so on. The difference between the samples then represents the difference between the peak and the trough, or the peak-to-peak amplitude of the received signal. In this mode, the second RGD (RGD(n+1)) may be an odd-integer-multiple of ½ the period of the ultrasound wave temporally delayed from the first RGD.

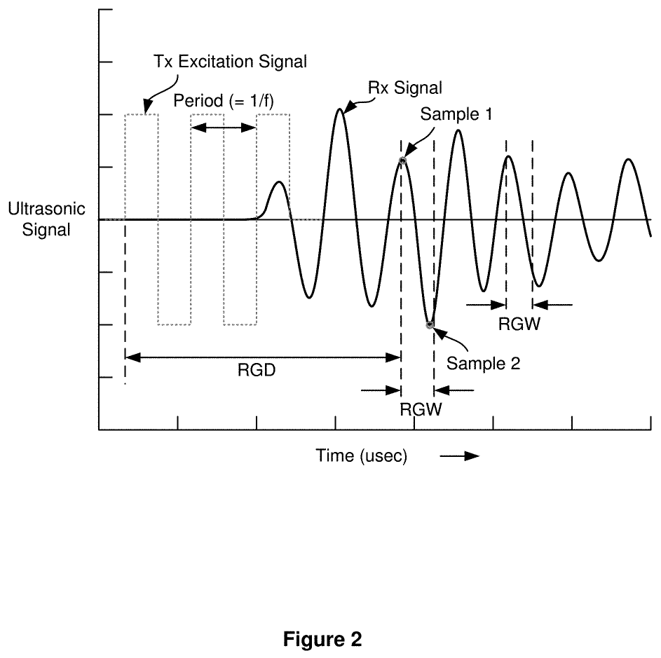

FIG. 2 illustrates a waveform view of an ultrasonic sensor response for a constant-delay differential sampling system, showing the initial RGD as calculated from the reference time of the start of transmission. In this example, the RGD for the first sample is shown is extending to the first sample, Sample 1. The range-gate-width, shown as RGW, represents the temporal delay between the first RGD (and Sample 1) and a second RGD (not shown). Here, the first sample is illustrated as being at a peak of the ultrasonic sensor response, and the second sample is shown as being at a trough of the ultrasonic sensor response, and the delay between Sample 1 and Sample 2 is ½ of the period of the response.

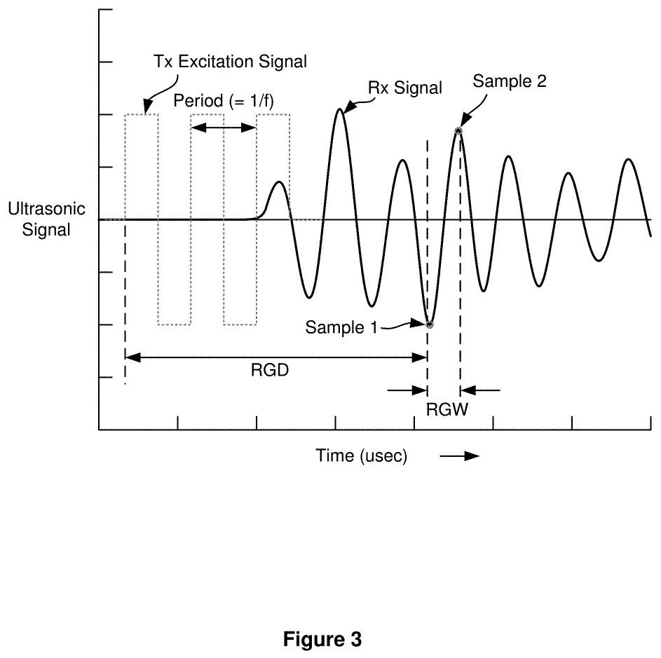

FIG. 3 illustrates a waveform view of an ultrasonic sensor response for a fixed-reference differential sampling system, showing the RGD for Sample 2 as calculated from the reference time of the start of transmission. In this example, the RGD for the second sample is shown is extending to the second sample, Sample 2. The range-gate-width, shown as RGW, represents the temporal delay between the first RGD (not shown) and a second RGD. Here, the first sample is illustrated as being at a trough of the ultrasonic sensor response, and the second sample is shown as being at a peak of the ultrasonic sensor response, and the delay between Sample 1 and Sample 2 is ½ of the period of the response.

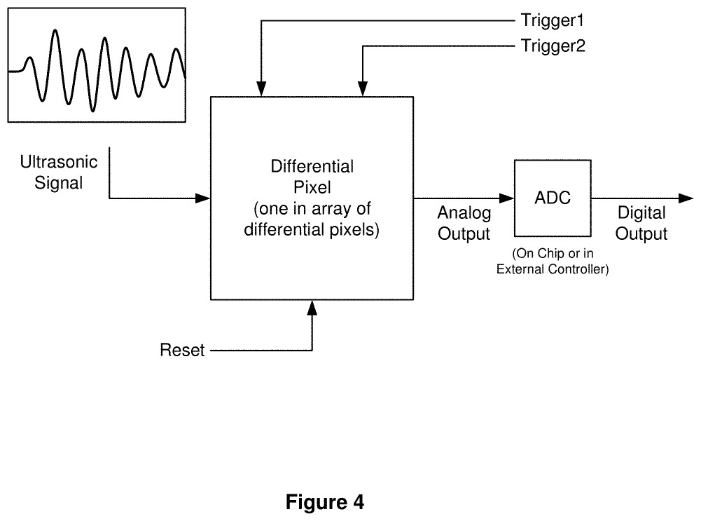

FIG. 4 illustrates an exemplary high-level block diagram of a differential-sampling system with an exemplary ultrasonic signal shown as an input to an ultrasonic pixel. The ultrasonic pixel of a sensor array has an input for a reset, a first trigger, and a second trigger. The inputs for the first trigger and second trigger may correspond to a single input, whereby a single signal is used to trigger the first and second sample. This would be the case, for example, where a first pulse on a trigger input triggers a first sample and a second pulse on a trigger input triggers a second sample. In another embodiment, a rising edge of a pulse may trigger a first sample and a falling edge of the same pulse may trigger a second sample.

The Reset input may be used, for example, prior to or after the transmission of an ultrasound wave in order to reset the pixel to a quiescent state. The Analog Output of the Pixel is routed to an ADC, which may be an on-chip controller, an ASIC, a DSP, or a processor, and the digital output may be routed for further processing.

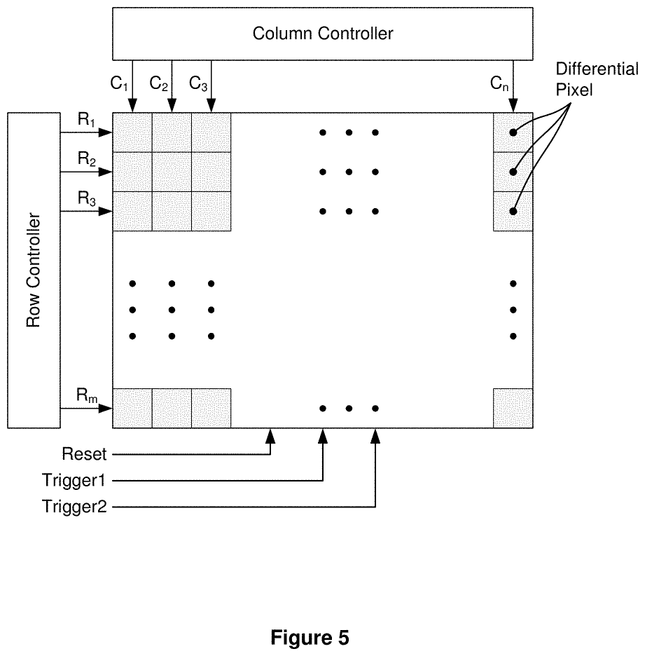

FIG. 5 illustrates an exemplary differential pixel array where each row in the differential pixel array is controlled by a row controller, each column in the differential pixel array is controlled by a column controller, and each differential pixel in the array is controlled by the same Rest, Trigger 1, and Trigger 2, and the output of each differential pixel is digitized by an ADC.

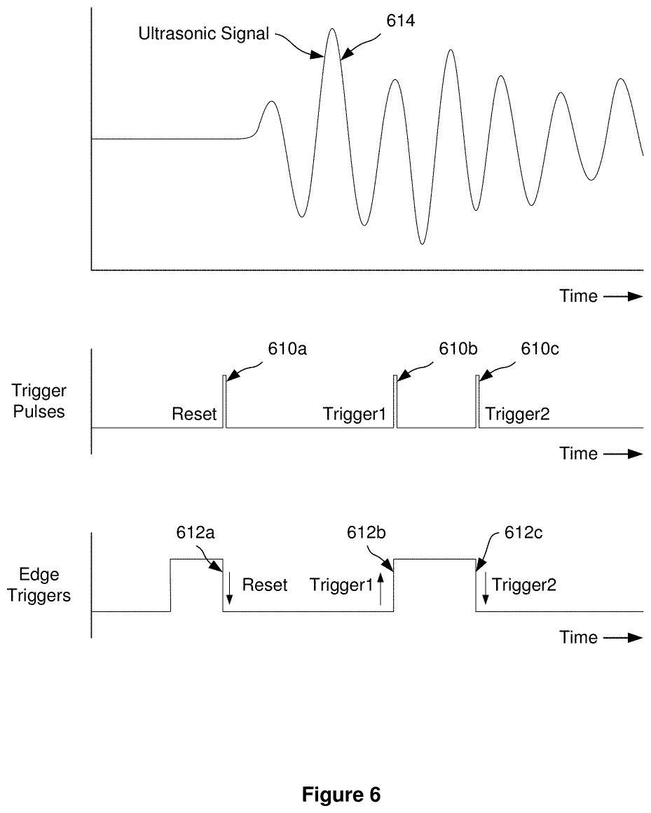

FIG. 6 illustrates an exemplary waveform view of two control signal types, a pulse control signal type 610 and a trailing-edge control signal type 612, with an accompanying ultrasonic signal 614. For the pulse control signal type 610, the control signal pulse including a rising and a falling edge is used for a Reset signal 610a, a Trigger 1 signal 610b, and a Trigger 2 signal 610c. For the trailing-edge control signal type 612, a pulse is sent for a Reset 612a, but the first sample is triggered on the rising edge which constitutes a trailing-edge Trigger 1 612b and the second sample is triggered on the falling edge which constitutes a trailing-edge Trigger 2 612c.

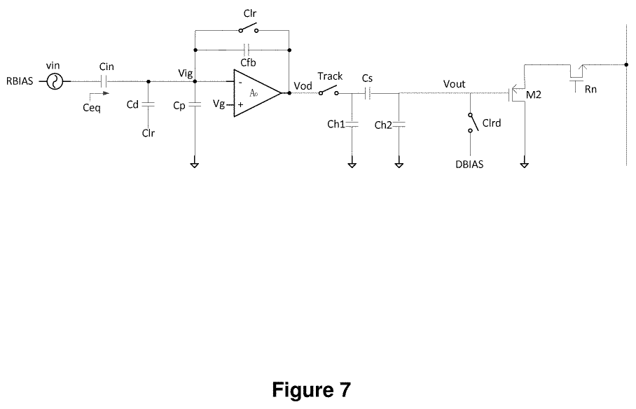

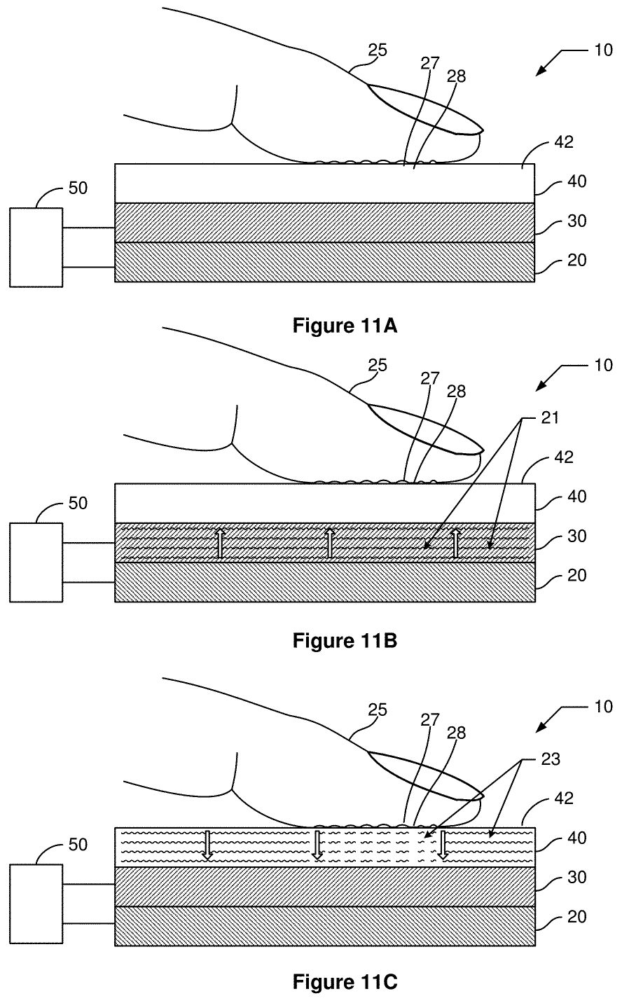

FIG. 7 illustrates an exemplary circuit diagram for ultrasonic differential-sampling. The gain of the amplifier is controlled by Cfb/Cin, as long as Cfb is not shorted. The pixel gain is zero as long as the Clr switch is closed. The input of the source-follower M2 is the DBIAS value (typically stable and is generated by an LDO [not shown]) as long as the Clrd switch is on. When the Clr switch opens, the pixel resets. The first sample is taken when the Clrd switch opens (Trigger 1). The second sample is taken when the Track switch opens (Trigger 2). This circuit may be part of a control system 50 as shown in FIG. 11A-C.

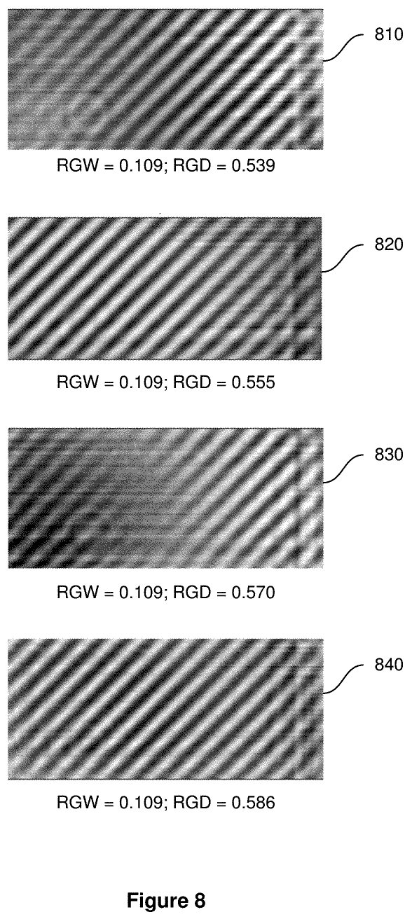

FIG. 8 illustrates a set of four sample images 810, 820, 830, and 840, taken with ultrasonic differential-sampling which may be processed with a point-spread function to correct for the diffraction effects of a glass touchscreen (which may comprise the platen of a fingerprint reader). A set of four such sample images 810, 820, 830, and 840 may be used to reconstruct a final image and to remove inversions using de-convolution algorithms.

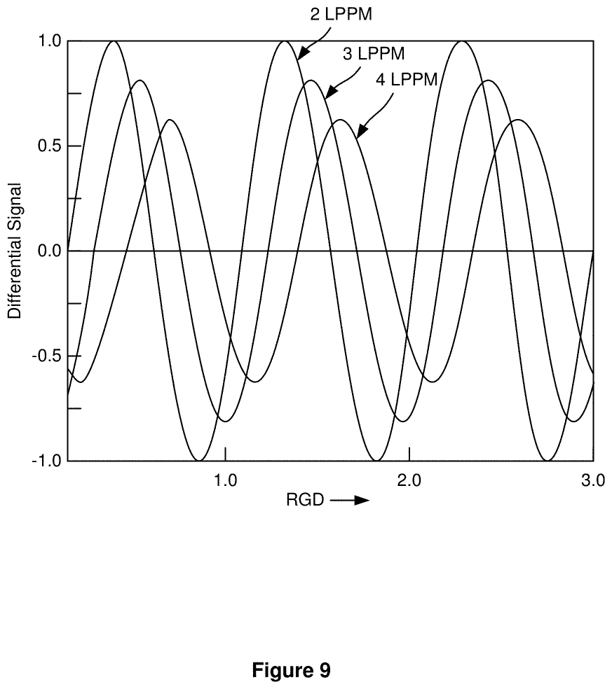

FIG. 9 illustrates an exemplary set of three superimposed waveforms from separate biometric images showing that each individual sample does not necessarily have to be at either the peak or trough of an ultrasonic signal. For example, in order to calculate a peak-to-peak amplitude of the ultrasonic signal, a sample from a trough of one ultrasonic waveform may be subtracted from a peak of a different ultrasonic waveform.

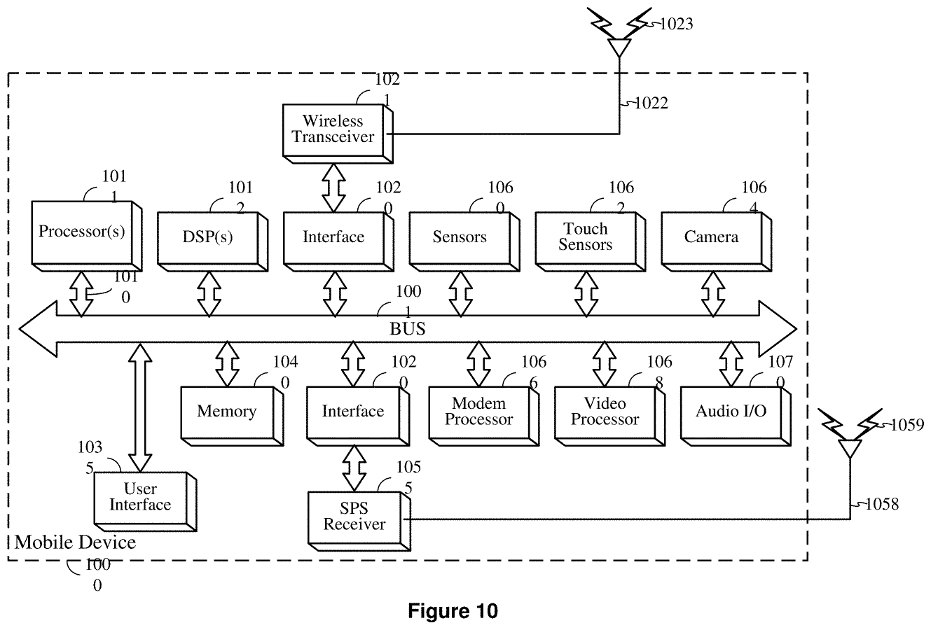

FIG. 10 illustrates an exemplary block diagram of a device that may include an ultrasonic fingerprint sensor configured to detect liveness of a finger according to aspects of the present disclosure. The device that may be configured to detect liveness of a finger may comprise one or more features of mobile device 1000 shown in FIG. 10. In certain embodiments, mobile device 1000 may include a wireless transceiver 1021 that is capable of transmitting and receiving wireless signals 1023 via wireless antenna 1022 over a wireless communication network. Wireless transceiver 1021 may be connected to bus 1001 by a wireless transceiver bus interface 1020. Wireless transceiver bus interface 1020 may, in some embodiments be at least partially integrated with wireless transceiver 1021. Some embodiments may include multiple wireless transceivers 1021 and wireless antennas 1022 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth®, etc.

Mobile device 1000 may also comprise GPS receiver 1055 capable of receiving and acquiring GPS signals 1059 via GPS antenna 1058. GPS receiver 1055 may also process, in whole or in part, acquired GPS signals 1059 for estimating a location of a mobile device. In some embodiments, processor(s) 1011, memory 1040, DSP(s) 1012 and/or specialized processors (not shown) may also be utilized to process acquired GPS signals, in whole or in part, and/or calculate an estimated location of mobile device 1000, in conjunction with GPS receiver 1055. Storage of GPS or other signals may be performed in memory 1040 or registers (not shown).

Also shown in FIG. 10, mobile device 1000 may comprise digital signal processor(s) (DSP(s)) 1012 connected to the bus 1001 by a bus interface 1010, processor(s) 1011 connected to the bus 1001 by a bus interface 1010 and memory 1040. Bus interface 1010 may be integrated with the DSP(s) 1012, processor(s) 1011 and memory 1040. In various embodiments, functions may be performed in response execution of one or more machine-readable instructions stored in memory 1040 such as on a computer-readable storage medium, such as RAM, ROM, FLASH, or disc drive, just to name a few examples. The one or more instructions may be executable by processor(s) 1011, specialized processors, or DSP(s) 1012. Memory 1040 may comprise a non-transitory processor-readable memory and/or a computer-readable memory that stores software code (programming code, instructions, etc.) that are executable by processor(s) 1011 and/or DSP(s) 1012 to perform functions described herein. In a particular implementation, wireless transceiver 1021 may communicate with processor(s) 1011 and/or DSP(s) 1012 through bus 1001 to enable mobile device 1000 to be configured as a wireless station. Processor(s) 1011 and/or DSP(s) 1012 may execute instructions to execute one or more aspects of processes/methods discussed in connection with FIGS. 1A-1C through FIGS. 6A-6C. Processor(s) 1011 and/or DSP(s) 1012 may perform the methods and functions as a part of the controller described in FIGS. 1A-1C through FIGS. 6A-6C.

Also shown in FIG. 10, a user interface 1035 may comprise any one of several devices such as, for example, a speaker, microphone, display device, vibration device, keyboard, touch screen, etc. A user interface signal provided to a user may be one or more outputs provided by any of the speaker, microphone, display device, vibration device, keyboard, touch screen, etc. In a particular implementation, user interface 1035 may enable a user to interact with one or more applications hosted on mobile device 1000. For example, devices of user interface 1035 may store analog or digital signals on memory 1040 to be further processed by DSP(s) 1012 or processor 1011 in response to action from a user. Similarly, applications hosted on mobile device 1000 may store analog or digital signals on memory 1040 to present an output signal to a user. In another implementation, mobile device 1000 may optionally include a dedicated audio input/output (I/O) device 1070 comprising, for example, a dedicated speaker, microphone, digital to analog circuitry, analog to digital circuitry, amplifiers and/or gain control. In another implementation, mobile device 1000 may comprise touch sensors 1062 responsive to touching or pressure on a keyboard or touch screen device.

Mobile device 1000 may also comprise a dedicated camera device 1064 for capturing still or moving imagery. Dedicated camera device 1064 may comprise, for example an imaging sensor (e.g., charge coupled device or CMOS imager), lens, analog to digital circuitry, frame buffers, etc. In one implementation, additional processing, conditioning, encoding or compression of signals representing captured images may be performed at processor 1011 or DSP(s) 1012. Alternatively, a dedicated video processor 1068 may perform conditioning, encoding, compression or manipulation of signals representing captured images. Additionally, dedicated video processor 1068 may decode/decompress stored image data for presentation on a display device (not shown) on mobile device 1000.

Mobile device 1000 may also comprise sensors 1060 coupled to bus 1001 which may include, for example, inertial sensors and environment sensors. Inertial sensors of sensors 1060 may comprise, for example accelerometers (e.g., collectively responding to acceleration of mobile device 1000 in three dimensions), one or more gyroscopes or one or more magnetometers (e.g., to support one or more compass applications). Environment sensors of mobile device 1000 may comprise, for example, temperature sensors, barometric pressure sensors, ambient light sensors, and camera imagers, microphones, just to name few examples. Sensors 1060 may generate analog or digital signals that may be stored in memory 1040 and processed by DPS(s) or processor 1011 in support of one or more applications such as, for example, applications directed to positioning or navigation operations.

In a particular implementation, mobile device 1000 may comprise a dedicated modem processor 1066 capable of performing baseband processing of signals received and down-converted at wireless transceiver 1021 or GPS receiver 1055. Similarly, dedicated modem processor 1066 may perform baseband processing of signals to be up-converted for transmission by wireless transceiver 1021. In alternative implementations, instead of having a dedicated modem processor, baseband processing may be performed by a processor or DSP (e.g., processor 1011 or DSP(s) 1012).

FIGS. 11A-11C illustrate an example of an ultrasonic sensor according to aspects of the present disclosure. As shown in FIG. 11A, ultrasonic sensor 10 may include an ultrasonic transmitter 20 and an ultrasonic receiver 30 under a platen 40. The ultrasonic transmitter 20 may be a piezoelectric transmitter that can generate ultrasonic waves 21 (see FIG. 11B). The ultrasonic receiver 30 may include a piezoelectric material and an array of pixel circuits disposed on a substrate. In operation, the ultrasonic transmitter 20 generates one or more ultrasonic waves that travel through the ultrasonic receiver 30 to the exposed surface 42 of the platen 40. At the exposed surface 42 of the platen 40, the ultrasonic energy may be transmitted, absorbed or scattered by an object 25 that is in contact with the platen 40, such as the skin of a fingerprint ridge 28, or reflected back. In those locations where air contacts the exposed surface 42 of the platen 40, e.g., valleys 27 between fingerprint ridges 28, most of the ultrasonic wave will be reflected back toward the ultrasonic receiver 30 for detection (see FIG. 11C). Control electronics 50 may be coupled to the ultrasonic transmitter 20 and ultrasonic receiver 30 and may supply timing signals that cause the ultrasonic transmitter 20 to generate one or more ultrasonic waves 21. The control electronics 50 may then receive signals from the ultrasonic receiver 30 that are indicative of reflected ultrasonic energy 23. The control electronics 50 may use output signals received from the ultrasonic receiver 30 to construct a digital image of the object 25. In some implementations, the control electronics 50 may also, over time, successively sample the output signals to detect the presence and/or movement of the object 25.

According to aspects of the present disclosure, an ultrasonic sensor may include an ultrasonic transmitter 20 and an ultrasonic receiver 30 under a platen 40. The ultrasonic transmitter 20 may be a plane wave generator including a substantially planar piezoelectric transmitter layer. Ultrasonic waves may be generated by applying a voltage to the piezoelectric layer to expand or contract the layer, depending upon the signal applied, thereby generating a plane wave. The voltage may be applied to the piezoelectric transmitter layer via a first transmitter electrode and a second transmitter electrode. In this fashion, an ultrasonic wave may be made by changing the thickness of the layer via a piezoelectric effect. This ultrasonic wave travels toward a finger (or other object to be detected), passing through the platen 40. A portion of the wave not absorbed or transmitted by the object to be detected may be reflected so as to pass back through the platen 40 and be received by the ultrasonic receiver 30. The first and second transmitter electrodes may be metallized electrodes, for example, metal layers that coat opposing sides of the piezoelectric transmitter layer.

The ultrasonic receiver 30 may include an array of pixel circuits disposed on a substrate, which also may be referred to as a backplane, and a piezoelectric receiver layer. In some implementations, each pixel circuit may include one or more TFT elements, electrical interconnect traces and, in some implementations, one or more additional circuit elements such as diodes, capacitors, and the like. Each pixel circuit may be configured to convert an electric charge generated in the piezoelectric receiver layer proximate to the pixel circuit into an electrical signal. Each pixel circuit may include a pixel input electrode that electrically couples the piezoelectric receiver layer to the pixel circuit.

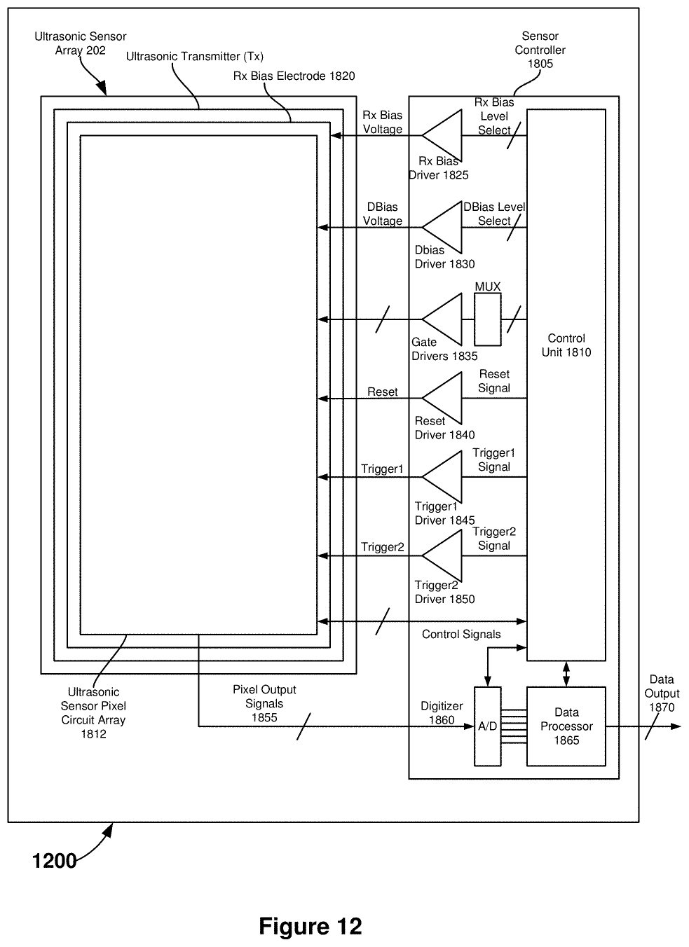

In the illustrated implementation, a receiver bias electrode is disposed on a side of the piezoelectric receiver layer proximal to platen 40. The receiver bias electrode may be a metallized electrode and may be grounded or biased to control which signals are passed to the TFT array. Ultrasonic energy that is reflected from the exposed (top) surface 42 of the platen 40 is converted into localized electrical charges by the piezoelectric receiver layer. These localized charges are collected by the pixel input electrodes and are passed on to the underlying pixel circuits. The charges may be amplified by the pixel circuits and provided to the control electronics, which processes the output signals. A simplified schematic of an example pixel circuit is shown in FIG. 12, however one of ordinary skill in the art will appreciate that many variations of and modifications to the example pixel circuit shown in the simplified schematic may be contemplated.

Control electronics 50 may be electrically connected to the first transmitter electrode and the second transmitter electrode, as well as to the receiver bias electrode and the pixel circuits on the substrate. The control electronics 50 may operate substantially as discussed previously with respect to FIGS. 11A-11C.

The platen 40 may be any appropriate material that can be acoustically coupled to the receiver, with examples including plastic, ceramic, glass, sapphire, stainless steel, a metal alloy, polycarbonate, a polymeric material, or a metal-filled plastic. In some implementations, the platen 40 can be a cover plate, e.g., a cover glass or a lens glass for a display device or an ultrasonic button. Detection and imaging can be performed through relatively thick platens if desired, e.g., 3 mm and above.

Examples of piezoelectric materials that may be employed according to various implementations include piezoelectric polymers having appropriate acoustic properties, for example between about 2.5 MRayls and 5 MRayls. Specific examples of piezoelectric materials that may be employed include ferroelectric polymers such as polyvinylidene fluoride (PVDF) and polyvinylidene fluoride-trifluoroethylene (PVDF-TrFE) copolymers. Examples of PVDF copolymers include 60:40 (molar percent) PVDF-TrFE, 70:30 PVDF-TrFE, 80:20 PVDF-TrFE, and 90:10 PVDR-TrFE. Other examples of piezoelectric materials that may be employed include polyvinylidene chloride (PVDC) homopolymers and copolymers, polytetrafluoroethylene (PTFE) homopolymers and copolymers, and diisopropylammonium bromide (DIPAB).

The thickness of each of the piezoelectric transmitter layer and the piezoelectric receiver layer may be selected so as to be suitable for generating and receiving ultrasonic waves. In one example, a PVDF piezoelectric transmitter layer is approximately 28 μm thick and a PVDF-TrFE receiver layer is approximately 12 μm thick. Example frequencies of the ultrasonic waves are in the range of 5 MHz to 30 MHz, with wavelengths on the order of a quarter of a millimeter or less.

FIGS. 11A-11C show example arrangements of ultrasonic transmitters and receivers in an ultrasonic sensor, with other arrangements possible. For example, in some implementations, the ultrasonic transmitter 20 may be above the ultrasonic receiver 30, i.e., closer to the object of detection. In some implementations, the ultrasonic sensor may include an acoustic delay layer. For example, an acoustic delay layer can be incorporated into the ultrasonic sensor 10 between the ultrasonic transmitter 20 and the ultrasonic receiver 30. An acoustic delay layer can be employed to adjust the ultrasonic pulse timing, and at the same time electrically insulate the ultrasonic receiver 30 from the ultrasonic transmitter 20. The delay layer may have a substantially uniform thickness, with the material used for the delay layer and/or the thickness of the delay layer selected to provide a desired delay in the time for reflected ultrasonic energy to reach the ultrasonic receiver 30. In doing so, the range of time during which an energy pulse that carries information about the object by virtue of having been reflected by the object may be made to arrive at the ultrasonic receiver 30 during a time range when it is unlikely that energy reflected from other parts of the ultrasonic sensor 10 is arriving at the ultrasonic receiver 30. In some implementations, the TFT substrate and/or the platen 40 may serve as an acoustic delay layer.

FIG. 12 shows an example of a high-level block diagram of an ultrasonic sensor system. Many of the elements shown may form part of control electronics 50. A sensor controller may include a control unit that is configured to control various aspects of the sensor system, e.g., ultrasonic transmitter timing and excitation waveforms, bias voltages for the ultrasonic receiver and pixel circuitry, pixel addressing, signal filtering and conversion, readout frame rates, and so forth. The sensor controller may also include a data processor that receives data from the ultrasonic sensor circuit pixel array. The data processor may translate the digitized data into image data of a fingerprint or format the data for further processing.

For example, the control unit may send a transmitter (Tx) excitation signal to a Tx driver at regular intervals to cause the Tx driver to excite the ultrasonic transmitter and produce planar ultrasonic waves. The control unit may send level select input signals through a receiver (Rx) bias driver to bias the receiver bias electrode and allow gating of acoustic signal detection by the pixel circuitry. The control unit may also send Reset and Trigger 1 and Trigger 2 signals to the ultrasonic sensor pixel array. A demultiplexer may be used to turn on and off gate drivers that cause a particular row or column of sensor pixel circuits to provide sensor output signals. Output signals from the pixels may be sent through a charge amplifier, a filter such as an RC filter or an anti-aliasing filter, and a digitizer to the data processor. Note that portions of the system may be included on the TFT backplane and other portions may be included in an associated integrated circuit.

Having described in some detail an example ultrasonic fingerprint sensor, the following discussion addresses characteristics of typical display modules. There are many different technologies that may be used to provide modern, pixelated display devices for use in computer monitors, televisions, mobile devices, and other electronic equipment. Liquid crystal displays (LCDs) and organic light-emitting diode (OLED) displays are examples of two such technologies. As mentioned previously, many of the examples in this disclosure focus on integration of an ultrasonic fingerprint sensor with an LCD-type display architecture, although the general techniques, design rules, and concepts outlined herein may also be applied to other types of display technology as well.

In LCDs, light emitted from a uniformly-illuminated backlight passes through two polarizers that are parallel to one another but oriented with their polarization axes perpendicular to one another. An array of liquid crystal cells, or pixels, is interposed between the two polarizers. Each liquid crystal cell is typically configured such that the liquid crystal inside “relaxes” into a “twisted nematic state” when no voltage is applied to the liquid crystal cell. In the twisted nematic state, the liquid crystal causes polarized light passing through the polarizer interposed between the liquid crystal cell and the backlight to be twisted by 90°, allowing the light to then pass through the remaining polarizer.

When a voltage is applied across a liquid crystal cell, the liquid crystal untwists, causing the initially polarized light passing through the liquid crystal to be twisted to a lesser degree, resulting in less transmission of the light through the second polarizer. The amount of twisting/untwisting of the light is dependent on the voltage applied, allowing the amount of light that passes through the dual-polarizer stack to be modulated. Each such liquid crystal cell may serve as a pixel or a subpixel of a display device. If color output is desired, a color filter array may be placed between the liquid crystal layer and the viewing surface of the display. The color filter array may filter the light that is produced by each pixel such that it is substantially monochromatic, e.g., red, green, or blue. By combining the output of multiple pixels, e.g., a red pixel, a green pixel, and a blue pixel, it may be possible to tune the blended color produced by each such pixel grouping. In such cases, the pixel elements may be referred to as subpixels, and each grouping of subpixels that may be tuned to produce blended light of a particular color may be referred to as a pixel.

OLED displays utilize a more direct technique for providing light. In OLED displays, each pixel, or subpixel, is a single light-emitting diode. Each diode may be individually controlled so as to produce a varying amount of light of a particular color. This bypasses the need for polarizer films and liquid crystal elements and reduces the amount of light that is “wasted” by a display panel as compared with an LCD display panel.

While LCDs and OLED displays use very different techniques for producing light, each type of display requires a mechanism for individually controlling each display pixel or subpixel. To provide such control, these displays utilize an array of thin-film transistors (TFTs). The TFTs for LCDs are commonly fabricated on a clear TFT backplane (also referred to herein as a backplane), e.g., a glass or transparent polymer, to facilitate light transmission from the backlight through the backplane and into the liquid crystal cells. The TFTs for OLED displays may also be manufactured on a clear backplane, although opaque backplanes may be used in such types of displays.

Each display pixel of a display module may include one or more TFTs that are arranged, sometimes in combination with other circuit elements, in a circuit that controls the behavior of that display pixel; such pixel-level circuits are referred to herein as display pixel circuits. The display pixel circuits are arranged on the backplane in an array that is substantially coextensive with the display pixel array. Rather than address all of the display pixel circuits controlling the pixels in the display simultaneously, which would require separate traces for each and every display pixel circuit, the control electronics for such display modules typically sequentially “scan” through each row or column of the display pixel circuits at a very high frequency. To facilitate such control, each column may, for example, have a separate “data” line or trace, and each row may have a separate “scan” line or trace. Alternatively, each row may have a separate data line or trace, and each column may have a separate scan line or trace. Each display pixel circuit may typically be connected to one scan trace and one data trace. Typically, power is applied to the scan traces one at a time and while power is applied to a particular scan trace, the display pixel circuits associated with the powered scan trace may be individually controlled by signals applied to their respective data traces.

The use of a scanning arrangement allows the number of individual traces that can be accommodated for a display to be reduced from potentially millions of traces to hundreds or thousands of traces. This, however, is still an undesirably large number of traces to deal with, and so display panels often include one or more driver chips that communicate with each data trace and scan trace and that translate image data provided from an input or set of inputs into sequential sets of scan signals and data signals that are output to the scan traces and the data traces. Driver chips are typically connected to a processor or other device that provides image data via a flex cable having tens or hundreds of conductors. Thus, a multimillion pixel display may be controlled by a flexible cable having a drastically lower number of conductors, e.g., on the order of 4-6 orders of magnitude lower.

Such driver chips may be considerably smaller in footprint than the display may be. To accommodate such a size differential, the spacing between the data traces and/or scan traces may be reduced between the display pixel circuit array and the driver chip. From the perspective of the driver chip, the traces may appear to “fan out” towards the array of display pixel circuits, referred to herein as “fanout.” To accommodate the driver chip or chips and the respective fan-out, the TFT backplane may be sized larger than the array of display pixel circuits. In some cases, the fanout does not terminate at a driver chip, but instead terminates at a flex cable connection. The driver chip in such cases may be located on a component at the opposing terminal end of the flex cable.

Note that the TFT backplane for a display module may, within minimal or no alteration of existing circuit patterning, be designed to accommodate a second array of pixel circuits in the vicinity of the fanout. Such a second array of pixel circuits may be used to provide ultrasonic sensing functionality to a non-display region of the display device; accordingly, the pixel circuits in the second array may be referred to herein as sensor pixel circuits (as opposed to the display pixel circuits discussed earlier). Such sensing functionality may, for example, be used to provide an ultrasonic fingerprint sensing capability. Note that this may be of particular interest in mobile electronic devices to allow for biometric identification measures to be implemented in an aesthetically-pleasing manner on the device to help secure the device and the data therein in the event of loss or theft.

According to aspects of the present disclosure, ultrasonic sensors can be configured to produce high-resolution fingerprint images for user verification and authentication. In some implementations, ultrasonic fingerprint sensors can be configured to detect reflected signals proportional to the differential reflected acoustic energy between an outer surface of a platen and a finger ridge (tissue) and valley (air). For example, a portion of the ultrasonic wave energy of an ultrasonic wave may be transmitted from the sensor into finger tissue in the ridge areas while the remaining portion of the ultrasonic wave energy is reflected back towards the sensor, whereas a smaller portion of the wave may be transmitted into the air in the valley regions of the finger while the remaining portion of the ultrasonic wave energy is reflected back to the sensor. Methods of correcting diffraction effects disclosed herein may increase the overall signal and image contrast from the sensor.

According to aspects of the present disclosure, ultrasonic buttons with fingerprint sensors can be applied for user authentication in a wide range of applications, including mobile phones, tablet computers, wearable devices and medical devices. Ultrasonic authenticating buttons may be utilized in personal medical devices such as drug delivery devices. These devices may be wirelessly connected to track and verify the identification of a user, type of drug, dosage, time of delivery, and style of delivery. The on-device authenticating button can be configured to allow single-user enrollment (e.g., at home or at a pharmacy) and local verification for subsequent consumption of the drug. Rapid identification and verification may appear seamless with the delivery of the drug, as depressions of the ultrasonic button can be configured to invoke user verification and drug delivery. Mobile-connected authenticated drug delivery devices may include personalized pen-injectors and inhalers. Connected injector pens, inhalers and other medical devices may incorporate an ultrasonic button for patient identification and verification.

The methodologies described herein may be implemented by various means depending upon applications according to particular examples. For example, such methodologies may be implemented in hardware, and firmware/software. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method for biometric sampling by an ultrasonic fingerprint sensor comprising:
transmitting, by an ultrasonic transmitter, an ultrasonic wave whereby the ultrasonic wave reflects from an object;
performing successive differential-sampling operations, with a differential pixel of an ultrasonic pixel array, to determine a set of sample differences, the differential-sampling operation comprising:
capturing, with the differential pixel, a sample(n) of the reflected ultrasonic wave at an RGD(n);
capturing, with the differential pixel, a sample(n+1) of the reflected ultrasonic wave at an RGD(n+1);
determining a sample difference between sample(n) and sample(n+1);
wherein RGD(n) and RGD(n+1) change for each successive differential sampling operation;
and processing the set of sample differences to create at least a portion of biometric image data.

2. The method of claim 1, further comprising:
acquiring foreground-off and background-off image data; and
processing the portion of biometric image data, at least a portion of foreground-off data, and at least a portion of background-off data, to create a noise-reduced biometric image.

3. The method of claim 1, further comprising:
sending a reset signal to at least one differential pixel of the ultrasonic pixel array after a start of a transmit signal is sent to the ultrasonic transmitter.

4. The method of claim 1, wherein RGD(n+1) is longer than RGD(n).

5. The method of claim 1, wherein the sample(n) and sample(n+1) are triggered by input pulses of a control waveform to the differential pixel.

6. The method of claim 1, wherein the sample(n) is triggered by a rising-edge of an input signal and sample(n+1) is triggered by a falling edge of an input signal.

7. The method of claim 1, wherein a temporal delay between RGD(n+1) and RGD(n) is an odd-integer-multiple of half the period of an ultrasonic transmitter wave drive frequency.

8. The method of claim 2, further comprising operating a point-spread function (PSF) upon a combination of multiple noise-reduced biometric images.

9. A method for biometric sampling by an ultrasonic fingerprint sensor comprising:
transmitting, by an ultrasonic transmitter, an ultrasonic wave whereby the ultrasonic wave reflects from an object;
capturing, with a differential pixel, a sample(n) of the reflected ultrasonic wave at an RGD(n);
performing successive differential-sampling operations, with the differential pixel of an ultrasonic pixel array, to determine a set of sample differences, the differential-sampling operation comprising:
capturing, with the differential pixel, a sample(n+1) of the reflected ultrasonic wave at an RGD(n+1);
determine a sample difference between sample(n) and sample(n+1);
wherein RGD(n+1) change for each successive differential sampling operation;
and processing the set of sample differences to create at least a portion of biometric image data.

10. The method of claim 9, further comprising:
acquiring foreground-off and background-off image data; and
processing the portion of biometric image data, at least a portion of foreground-off data, and at least a portion of background-off data, to create a noise-reduced biometric image.

11. The method of claim 9, further comprising:
sending a reset signal to at least one differential pixel of the ultrasonic pixel array after a start of a transmit signal is sent to the ultrasonic transmitter.

12. The method of claim 9, wherein RGD(n+1) is longer than RGD(n).

13. The method of claim 9, wherein the sample(n) and sample(n+1) are triggered by input pulses of a control waveform to the differential pixel.

14. The method of claim 9, wherein a temporal delay between RGD(n+1) and RGD(n) is an odd-integer-multiple of half the period of an ultrasonic transmitter wave drive frequency.

15. The method of claim 10, further comprising operating a point-spread function (PSF) upon a combination of multiple noise-reduced biometric images.

16. A biometric sampling apparatus, comprising:
an ultrasonic transmitter configured to transmit an ultrasound wave whereby the wave reflects from an object;
a controller configured to perform successive differential sampling operations, with a differential pixel of an ultrasonic pixel array, to determine a set of sample differences, wherein the controller is configured to:
capture, with the differential pixel, a sample(n) of the reflected ultrasonic wave at an RGD(n);
capture, with the differential pixel, a sample(n+1) of the reflected ultrasonic wave at an RGD(n+1);
determine a sample difference between sample(n) and sample(n+1);
wherein RGD(n) and RGD(n+1) change for each successive differential sampling operation;
the controller further configured to process the set of sample differences to create at least a portion of biometric image data.

17. The apparatus of claim 16, wherein the controller is further configured to:
acquire foreground-off and background-off image data; and
process the portion of biometric image data, and at least a portion of foreground-off data, and at least a portion of background-off data, to create a noise-reduced biometric image.

18. The apparatus of claim 16 wherein the controller is further configured to:
send a reset signal to at least one differential pixel of the ultrasonic pixel array after a start of a transmit signal is sent to the ultrasonic transmitter.

19. The apparatus of claim 16, wherein RGD(n+1) is longer than RGD(n).

20. The apparatus of claim 16, wherein the controller is further configured to trigger sample(n) and sample(n+1) by input pulses of a control waveform to the differential pixel.

21. The apparatus of claim 16, wherein a temporal delay between RGD(n+1) and RGD(n) is an odd-integer-multiple of half the period of an ultrasonic transmitter wave drive frequency.

22. The apparatus of claim 17, wherein the controller is further configured to operate a point-spread function (PSF) upon a combination of multiple noise-reduced biometric images.

23. A biometric sampling system, comprising:
an ultrasonic transmitter configured to transmit an ultrasound wave whereby the wave reflects from an object;
a controller configured to capture, with the differential pixel, a sample(n) of the reflected ultrasonic wave at an RGD(n);
the controller further configured to perform successive differential sampling operations, with a differential pixel of an ultrasonic pixel array, to determine a set of sample differences, wherein the controller is configured to:
capture, with the differential pixel, a sample(n+1) of the reflected ultrasonic wave at an RGD(n+1);
determine a sample difference between sample(n) and sample(n+1);
wherein RGD(n) and RGD(n+1) change for each successive differential sampling operation;
the controller further configured to process the set of sample differences to create at least a portion of biometric image data.

24. The apparatus of claim 23, wherein the controller is further configured to:
acquire foreground-off and background-off image data; and
process the portion of biometric image data, and at least a portion of foreground-off data, and at least a portion of background-off data, to create a noise-reduced biometric image.

25. The apparatus of claim 23 wherein the controller is further configured to:
send a reset signal to at least one differential pixel of the ultrasonic pixel array after a start of a transmit signal is sent to the ultrasonic transmitter.

26. The apparatus of claim 23, wherein RGD(n+1) is longer than RGD(n).

27. The apparatus of claim 23, wherein the controller is further configured to trigger sample(n) and sample(n+1) by input pulses of a control waveform to the differential pixel.

28. The apparatus of claim 23, wherein a temporal delay between RGD(n+1) and RGD(n) is an odd-integer-multiple of half the period of an ultrasonic transmitter wave drive frequency.

29. The apparatus of claim 24, wherein the controller is further configured to operate a point-spread function (PSF) upon a combination of multiple noise-reduced biometric images
